(19) United States
(12) Patent Application Publication
(10) Pub. No.: US 2017/0130944 A1
(43) Pub. Date: May 11, 2017

(54) Electromagnetically driven rotating lamp

(71) Applicant: Xingze TU, Fujian (CN)

(72) Inventor: Xingze TU, Fujian (CN)

(21) Appl. No.: 15/145,790

(22) Filed: May 3, 2016

(30) Foreign Application Priority Data
Nov. 6, 2015 (CN) 201520878731.6

(51) Int. Cl. F21V 21/15; F21V 23/00

(52) U.S. Cl. CPC F21V 21/15; F21V 23/00

(57) ABSTRACT

An electromagnetically driven rotating lamp having a ground fixer, a circuit box and a lamp unit; and also comprises a drive mechanism for driving the circuit box to rotate, and also a circuit board; the drive mechanism has a support shaft, a magnetically sensitive device fixed inside the circuit box, and also a motion transmission assembly; a magnet corresponding to the magnetically sensitive device is provided on the motion transmission assembly; the support shaft is mounted on the circuit box and is rotatable with respect to the circuit box; a lower end of the support shaft is connected on the ground fixer and is not rotatable with respect to the ground fixer.

### BACKGROUND OF THE INVENTION

The present invention relates to the field of lamps, and more specifically relates to an electromagnetically driven rotating lamp.

Lamps used on lawns and gardens can be conveniently installed and are highly decorative. They are widely used in parks, apartments and green areas of plazas etc. Prior arts disclose a kind of solar powered lamp, for example in Chinese utility model patent publication number CN203744100U titled “a kind of solar powered lamp”, comprising an LED light electrically connected with solar panels; the LED light has a rotation shaft in its middle part connecting with a rotating lamp shade surrounding the LED light, and the rotation shaft is connected with an external small DC motor. In the above mentioned Chinese utility model, the rotation shaft can slowly rotate thanks to the small DC motor, thereby driving the transparent lamp shade to rotate as well. As such, the lighting patterns of the lighted areas move and rotate to create more vivid and vibrant lighting effects.

In another Chinese utility model patent publication number CN204254476U titled “a kind of solar powered decorative lamp used on lawns”, a solar powered decorative lamp used on lawn is disclosed comprising a lamp shade, an LED lights assembly, a circuit box, solar panels, lamp stand, connection rod and a ground fixer; the solar panels are provided on an upper surface of the circuit box and electrically connected with the circuit box; the solar panels recharge the accumulator batteries inside the circuit box; the circuit box is provided on the connection rod; one end of the connection rod is connected with the lamp stand; another end of the connection rod is connected with the ground fixer; the LED lights assembly is electrically connected with the circuit box via the wires running along inside the connection rod; the solar powered decorative lamp also comprises a motor and a motion transmission gears assembly. The motor and the motion transmission gears assembly are provided inside the lamp stand; a lamp support is provided on the lamp stand above the position which the motor and the motion transmission gears assembly are positioned, for accommodating the LED lights assembly; a power source end of the motor is connected with a power output end of the circuit box; according to the motion transmission gears assembly, a gear at the bottom layer drives multiple gears in a rotating step mode so that the gears can be mutually meshed and transfer horizontal rotating power upwards to drive all the gears to horizontally rotate; a motor output shaft is connected with the gear at the bottom layer of the motion transmission gears assembly to drive the gear at the bottom layer to rotate so as to drive all other gears in the motion transmission gears assembly to rotate; the gear at the uppermost layer of the transmission gear set partially protrudes out of the side edge of the lamp support; the lamp shade is an opaque lamp shade, and the opaque lamp shade is provided with a plurality of light transmitting holes; the lamp shade is rotatably mounted on the lamp stand; a teeth ring meshed with the gear at the uppermost layer is provided on an inner side wall of the lamp shade corresponding to the position where the uppermost layer of the transmission gear set partially protrudes out of the side edge of the lamp support; by means of the motor driving the gear at the bottom layer of the motion transmission gears assembly to rotate so as to drive the gear at the uppermost layer to rotate and thus driving the teeth ring to rotate, the lamp shade can be rotatably mounted on the lamp stand; the LED lights assembly is wired inside the lamp shade; the LED lights assembly comprises RGB LED lights; the circuit box controls switching of light emission of different lights of the LED lights assembly.

The lamp disclosed above drives the lamp shade to rotate by means of the motor and the motion transmission gears assembly. After the motor has been rotating for a long time, its capability of dissipating heat will be reduced, and thus affecting the service life of the lamp. Also, the motor renders the entire lamp to occupy more space and therefore affects the decorative purpose of the lamp.

In view of the aforesaid disadvantages, the present invention is provided after thorough study of the aforementioned problems.

### BRIEF SUMMARY OF THE INVENTION

An object of the present invention is to provide an electromagnetically driven rotating lamp which has compact structure and a longer service life.

To attain the above object, the present invention adopts the following technical scheme.

An electromagnetically driven rotating lamp, comprising a ground fixer, a circuit box rotatably mounted on top of the ground fixer, and a lamp unit connected to a top part of the circuit box; and also comprises a drive mechanism for driving the circuit box to rotate, and also a circuit board; the drive mechanism comprises a support shaft, a magnetically sensitive device fixed inside the circuit box, and also a motion transmission assembly; a magnet corresponding to the magnetically sensitive device is provided on the motion transmission assembly; the support shaft is mounted on the circuit box and is rotatable with respect to the circuit box; a lower end of the support shaft is connected on the ground fixer and is not rotatable with respect to the ground fixer.

As a preferred embodiment of the present invention, the lower end of the support shaft is provided with a blocking piece; an upper end of the ground fixer is provided with a blocking slot that matches with the blocking piece.

As a preferred embodiment of the present invention, the motion transmission assembly is a driving disc; the driving disc is fixed on the support shaft; the magnet is disposed on the driving disc.

As a preferred embodiment of the present invention, the motion transmission assembly comprises a driving gear and a set of motion transmission gears; the driving gear is fixed on the support shaft; the magnet is disposed on one of the set of motion transmission gears; an output end of the set of motion transmission gears is meshed with the driving gear.

As a preferred embodiment of the present invention, the circuit box comprises an upper cover and a lower cover; the upper cover and the lower cover are removably connected with each other; the lower cover is rotatably mounted at the upper end of the ground fixer.

As a variation of the structure of the present invention based on the idea of the present invention, the electromagnetically driven rotating lamp comprises a ground fixer, a circuit box rotatably mounted on top of the circuit box, and a lamp unit connected with a top part of the circuit box, and also comprises a drive mechanism for driving the circuit box to rotate, and also a circuit board; the drive mechanism comprises a support shaft, a magnetically sensitive device fixed on the support shaft, and a motion transmission assembly fixed inside the circuit box; a magnet corresponding to the magnetically sensitive device is provided on the motion transmission assembly; the support shaft is mounted on the circuit box and is rotatable with respect to the circuit box; a lower end of the support shaft is connected with the ground fixer and is not rotatable with respect to the ground fixer.

As a preferred embodiment of the aforementioned implementation of the present invention, the lower end of the support shaft is provided with a blocking piece, and an upper end of the ground fixer is provided with a blocking slot that matches with the blocking piece.

According to the technical scheme of the present invention, when the magnetically sensitive device is powered up and creates a magnetic field, the magnet will rotate under the effect of the magnetic field and hence drive the entire circuit box to rotate about the support shaft. The present invention uses electromagnetic drive to drive a conventional motor so as to omit structures like motor shell. Therefore, the entire drive mechanism can have better heat dissipation and therefore can prolong the service life of the rotating lamp. Moreover, the support shaft and the magnetically sensitive device are mutually staggered in terms of their positions so that the components inside the circuit box can be arranged more reasonably and the entire structure of the rotating lamp can be more compact. Besides, the driving method of the present invention has an advantage of low energy consumption.

### BRIEF DESCRIPTION OF THE DRAWINGS

FIG. 1 is a schematic structural view of the present invention.

FIG. 2 is a schematic structural view of the internal structure of the circuit box of the present invention according to the first embodiment.

FIG. 3 is a top plan view of the lower cover of the present invention.

FIG. 4 is a schematic structural view of the present invention according to the second embodiment.

FIG. 5 is a schematic structural view of the present invention according to the third embodiment.

FIG. 6 is a schematic structural view of the circuit box of the present invention, shown in another view angle.

In the figures:

| | | | |
|---|---|---|---|
| 10 | Ground fixer | 11 | Blocking slot |
| 20 | Circuit box | 21 | Upper cover |
| 22 | Lower cover | 30 | Lamp unit |
| 40 | Magnetically sensitive device | 50 | Support shaft |
| 51 | Blocking piece | 60 | Driving gear |
| 70 | Motion transmission assembly | 80 | Magnet |
| 90 | Circuit board | | |

### DETAILED DESCRIPTION OF THE INVENTION

The present invention is further described in detail below with reference to the figures in order to further explain the technical scheme of the present invention.

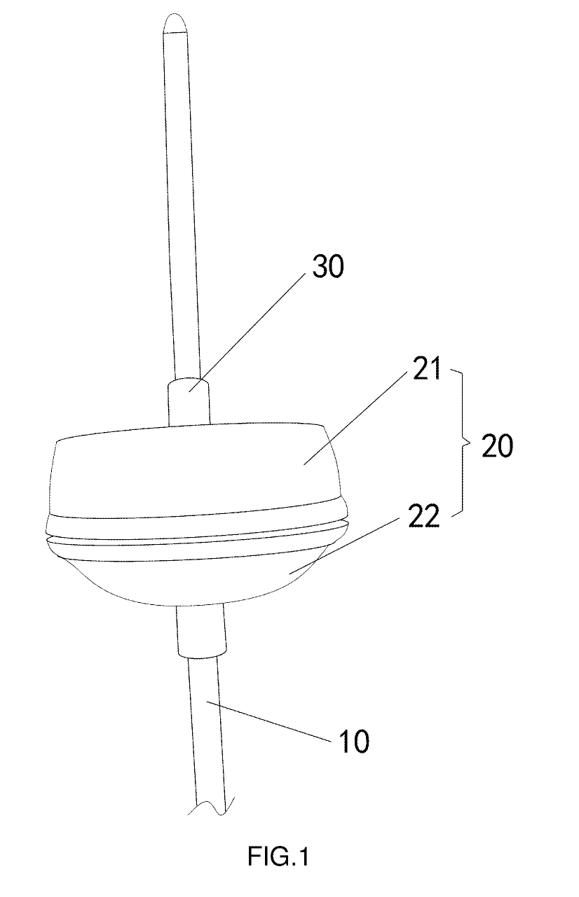

As shown in FIGS. 1 to 6, an electromagnetically driven rotating lamp comprises a ground fixer 10, a circuit box 20 rotatably mounted on top of the ground fixer 10, and a lamp unit 30 connected to a top part of the circuit box 20; and also comprises a drive mechanism for driving the circuit box 20 to rotate, and also a circuit board 90. Of course, a power source is provided inside the circuit box 20. The power source can be an electrical battery or a solar battery. The power source provides power to the circuit board 90, the lamp unit 30 and also a magnetically sensitive device 40 which will be described later.

In a first embodiment of the present invention, the drive mechanism comprises a support shaft 50, the magnetically sensitive device 40 fixed inside the circuit box 20, and also a motion transmission assembly 70. A magnet 80 corresponding to the magnetically sensitive device 40 is provided on the motion transmission assembly 70. The magnet 80 is a permanent magnet. The support shaft 50 is mounted on the circuit box 20 and is rotatable with respect to the circuit box 20. A lower end of the support shaft 50 is connected on the ground fixer 10 and is not rotatable with respect to the ground fixer 10. According to the present invention, a person skilled in this field of art may position the magnetically sensitive device 40 and the magnet 80 based on a specific shape of the circuit box 20, a specific shape of the magnetically sensitive device 40 and a specific shape of the magnet 80. The magnetically sensitive device 40 creates a magnetic field when being powered up. The magnetic field drives the magnet 80 to rotate and in turns drive the motion transmission assembly 70 to rotate. The technology of driving the magnet 80 by using the magnetically sensitive device 40 has been disclosed by the prior arts, and is now skillfully incorporated into the application relating to a rotating lamp.

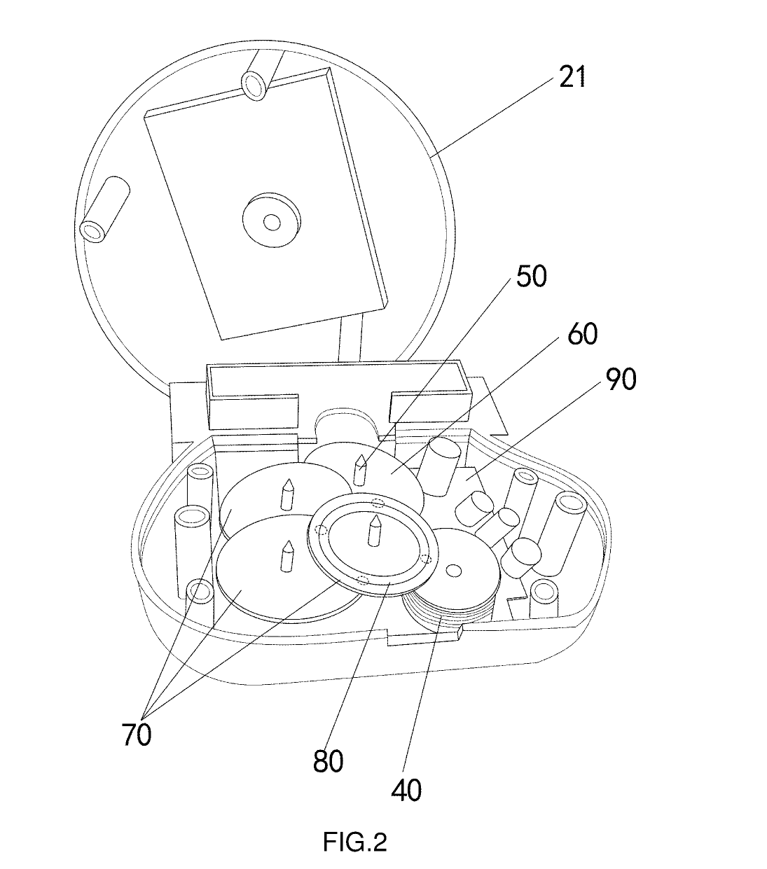

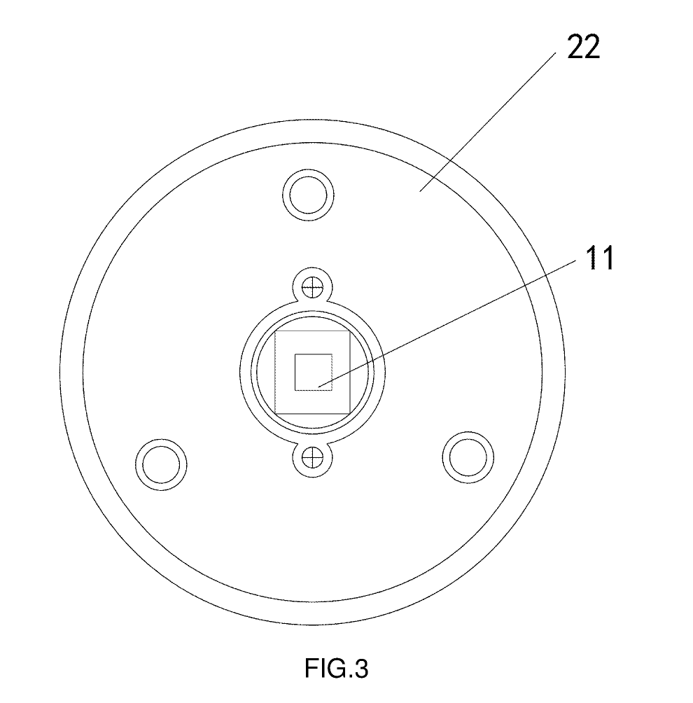

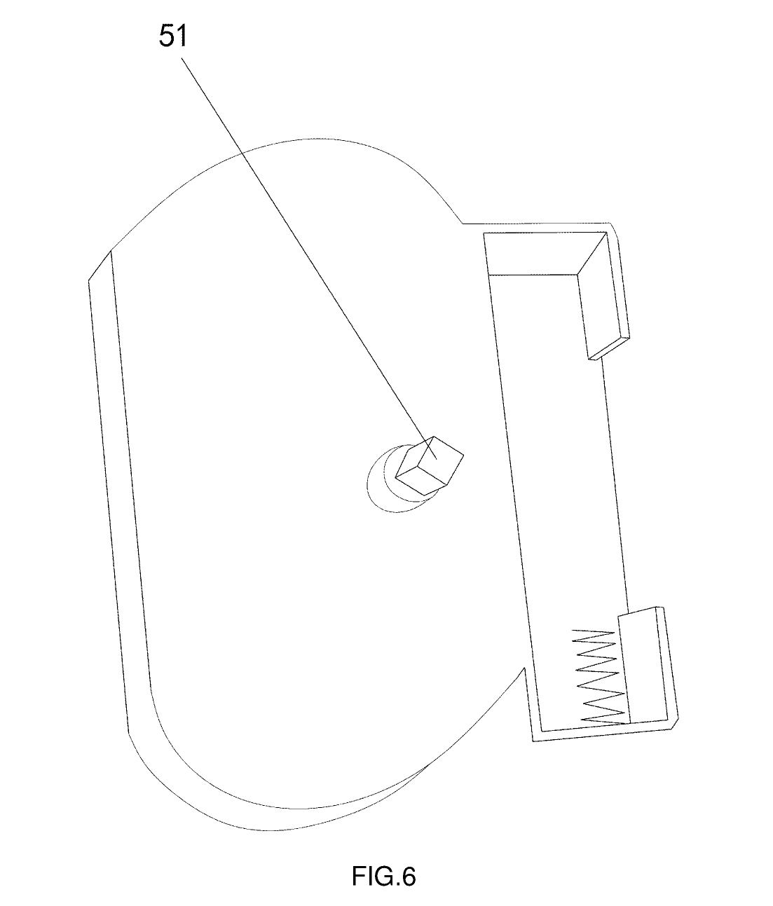

With reference to FIG. 2, FIG. 3 and FIG. 6, wherein FIG. 6 is the same as FIG. 2 but shown in another view angle (i.e. a bottom view of the structure shown in FIG. 2), a preferred embodiment of the present invention is shown, in which the lower end of the support shaft 50 is provided with a blocking piece 51. An upper end of the ground fixer 10 is provided with a blocking slot 11 that matches with the blocking piece 51. In the embodiment, the blocking slot 11 has a rectangular cross section. Correspondingly, the blocking piece 51 also has a rectangular cross section. When the blocking piece 51 is fixed into the blocking slot 11, the support shaft 50 cannot rotate with respect to the ground fixer 10. Accordingly, the support shaft 50 functions as a central axis of the rotation of the circuit box 20.

In FIG. 2, in order to better control the rotating speed of the circuit box 20, a first preferred embodiment of the present invention has the motion transmission assembly 70 comprising a driving gear 60 and a set of motion transmission gears. The motion transmission gears comprise a plurality of gears meshed with one another. The driving gear 60 is fixed on the support shaft 50. The magnet 80 is disposed on one of the set of motion transmission gears. An output end of the set of motion transmission gears is meshed with the driving gear 60. Accordingly, the motion transmission gears alter the motion transmission ratio so that the circuit box 20 may rotate about the support shaft 50 at a predetermined speed.

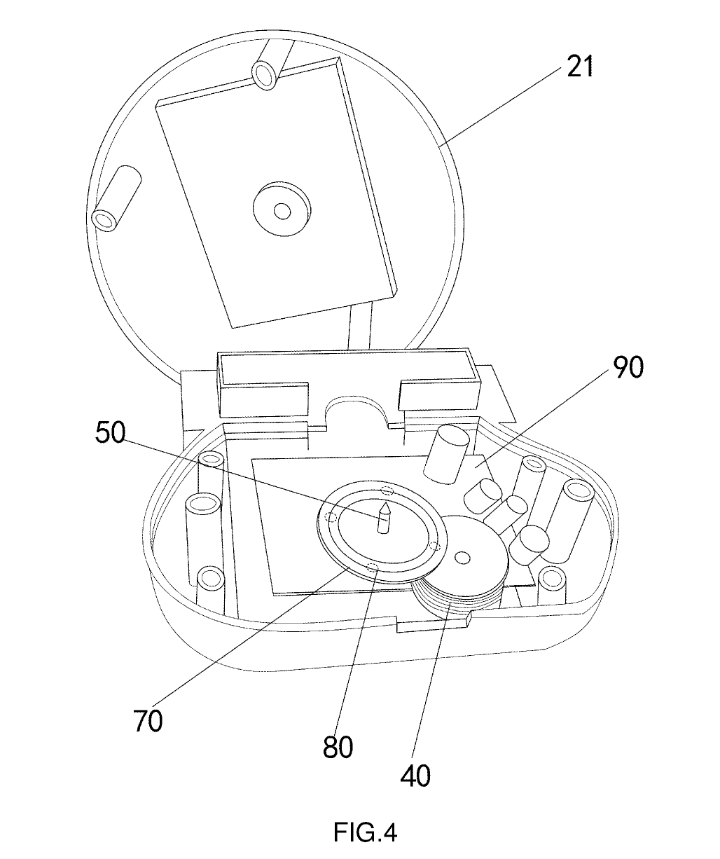

In FIG. 4, a second preferred embodiment of the present invention is shown, in which the motion transmission assembly 70 comprises a driving disc. The driving disc is fixed on the support shaft 50. The magnet 80 is disposed on the driving disc. According to such embodiment, a simple structure is obtained in which the circuit box 20 rotates about the support shaft 50 via direct utilization of interaction between the magnetically sensitive device 40 and the magnet 80.

In a preferred embodiment of the present invention, the circuit box 20 comprises an upper cover 21 and a lower cover 22. The upper cover 21 and the lower cover 22 are removably connected with each other. The lower cover 22 is rotatably mounted at the upper end of the ground fixer 10. In the embodiment, the upper cover 21 and the lower cover 22 are fixed together via screws so that the circuit box 20 can be easily disassembled for checking and maintenance.

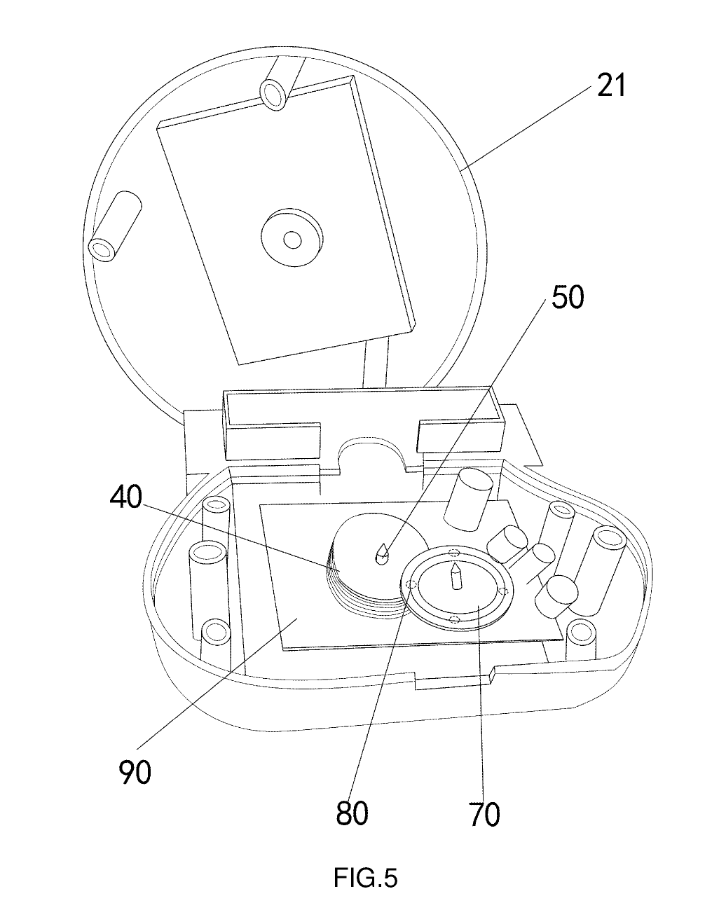

In the first embodiment of the present invention, the magnetically sensitive device 40 is fixed on the circuit box 20 and follows the circuit box 20 to rotate about the support shaft 50. As a variation of the present invention based on the same inventive concept of the present invention, a third embodiment of the present invention is shown with reference to FIG. 1, FIG. 3, FIG. 5 and FIG. 6, in which the electromagnetically driven rotating lamp may comprise a ground fixer 10, a circuit box 20 rotatably mounted on top of the ground fixer 10, and a lamp unit 30 connected with a top part of the circuit box 20, and may also comprise a drive mechanism for driving the circuit box to rotate, and also a circuit board 90. The drive mechanism comprises a support shaft 50, a magnetically sensitive device 40 fixed on the support shaft 50, and a motion transmission assembly 70 fixed inside the circuit box 20. A magnet 80 corresponding to the magnetically sensitive device 40 is provided on the motion transmission assembly 70. The support shaft 50 is mounted on the circuit box 20 and is rotatable with respect to the circuit box 20. A lower end of the support shaft 20 is connected with the ground fixer 10 and is not rotatable with respect to the ground fixer 10. As a preferred embodiment of the above implementation, the lower end of the support shaft 50 is provided with a blocking piece 51, and an upper end of the ground fixer 10 is provided with a blocking slot 11 that matches with the blocking piece 51.

By employing such a structure, the motion transmission assembly 70 is fixed inside the circuit box 20 while the magnetically sensitive device 40 is fixed on the support shaft 50. In order to avoid tangling of wires, another power source may be provided to supply power to the magnetically sensitive device 40, or the wires of the power source are rotatable with respect to the magnetically sensitive device 40 when supplying power to the magnetically sensitive device 40, and the choice of these designs may be decided by a person skilled in this technical field, and all these designs should fall within the scope of protection of the present invention.

During use of the present invention, the rotating lamp of the present invention can be fixed to the ground via the ground fixer 10. Alternatively, the ground fixer 10 can be fixed at a position away and high up from the ground so that rotating lamp of the present invention is hung up during use.

The present invention should not be limited to the figures and embodiments as shown and described. Any proper changes or modification in accordance with similar ideas of the present invention should not be considered deviated from the scope of the present invention.

What is claimed is:

1. An electromagnetically driven rotating lamp, comprising a ground fixer, a circuit box rotatably mounted on top of the ground fixer, and a lamp unit connected to a top part of the circuit box; and also comprises a drive mechanism for driving the circuit box to rotate, and also a circuit board; the drive mechanism comprises a support shaft, a magnetically sensitive device fixed inside the circuit box, and also a motion transmission assembly; a magnet corresponding to the magnetically sensitive device is provided on the motion transmission assembly; the support shaft is mounted on the circuit box and is rotatable with respect to the circuit box; a lower end of the support shaft is connected on the ground fixer and is not rotatable with respect to the ground fixer.

2. The electromagnetically driven rotating lamp according to claim 1, wherein the lower end of the support shaft is provided with a blocking piece; an upper end of the ground fixer is provided with a blocking slot that matches with the blocking piece.

3. The electromagnetically driven rotating lamp according to claim 1, wherein the motion transmission assembly is a driving disc; the driving disc is fixed on the support shaft; the magnet is disposed on the driving disc.

4. The electromagnetically driven rotating lamp according to claim 1, wherein the motion transmission assembly comprises a driving gear and a set of motion transmission gears; the driving gear is fixed on the support shaft; the magnet is disposed on one of the set of motion transmission gears; an output end of the set of motion transmission gears is meshed with the driving gear.

5. The electromagnetically driven rotating lamp according to claim 1, wherein the circuit box comprises an upper cover and a lower cover; the upper cover and the lower cover are removably connected with each other; the lower cover is rotatably mounted at an upper end of the ground fixer.

6. An electromagnetically driven rotating lamp comprising a ground fixer, a circuit box rotatably mounted on top of the circuit box, and a lamp unit connected with a top part of the circuit box, and also comprises a drive mechanism for driving the circuit box to rotate, and also a circuit board; the drive mechanism comprises a support shaft, a magnetically sensitive device fixed on the support shaft, and a motion transmission assembly fixed inside the circuit box; a magnet corresponding to the magnetically sensitive device is provided on the motion transmission assembly; the support shaft is mounted on the circuit box and is rotatable with respect to the circuit box; a lower end of the support shaft is connected with the ground fixer and is not rotatable with respect to the ground fixer.

7. The electromagnetically driven rotating lamp according to claim 6, wherein the lower end of the support shaft is provided with a blocking piece, and an upper end of the ground fixer is provided with a blocking slot that matches with the blocking piece.
